(19) United States
(12) Patent Application Publication
(10) Pub. No.: US 2008/0257388 A1
(43) Pub. Date: Oct. 23, 2008

(54) Gaming Chip Washing Machine

(75) Inventor: William Purton, Victoria (AU)

Correspondence Address: GREENBERG TRAURIG, 3773 HOWARD HUGHES PARKWAY, SUITE 500 NORTH, LAS VEGAS, NV, 89169, US

(73) Assignee: DOLPHIN ADVANCED TECHNOLOGIES PTY LTD, Heidelberg West (AU)

(21) Appl. No.: 11/571,731

(22) PCT Filed: Jul. 7, 2005
(86) PCT No.: PCT/AU05/00985

§ 371 Date: Jan. 29, 2008

(30) Foreign Application Priority Data
Jul. 8, 2004 (AU) 2004903731

(51) Int. Cl. B08B 7/04; B08B 3/02

(52) U.S. Cl. 134/62

(57) ABSTRACT

A machine for cleaning gaming chips or coins which includes means to convey individual coins or chips to a carrier wheel consisting of a vertically oriented disc having arranged about its periphery a plurality of coin or chip sized open recesses to receive individual coins or chips so that the coins or chips are supported on their edges and both faces of the coins or chips are exposed. The carrier wheel rotates through a washing station, a drying station arranged about said carrier wheel such that a drying air stream passes over and around said coins or chips in said carrier wheel. The coin or chip recesses in the carrier wheel are crenellated to allow washing fluid and the drying air stream to pass over the edges of the coins or chips. A total residence time for each chip that is sufficient to clean and dry the chips will lie in range of 10 to 20 seconds.

### BACKGROUND TO THE INVENTION

Gaming chips and coins become soiled and dirty through use and can become carriers of bacteria and microbes. The most common method of dealing with this problem is hand washing or discarding. This is usually considered to be time consuming and expensive.

In cleaning and drying the gaming chips the quality of the chip and its indicia must not be degraded.

Washing machines have been proposed for coins and chips but none have been commercially successful.

U.S. Pat. No. 5,538,562 discloses a coin cleaning system in which coins are transported lying on one face by a conveyor and then through pairs of brushes to effect the cleaning. The coins are dried by radiant heat as they are conveyed face down past a lamp.

U.S. Pat. No. 6,435,953 is a coin washing machine with a similar face down conveying mechanism.

WO/9916026 discloses a gaming chip washing machine in which the chips are supported on their edges in a conveyor belt with disc shaped recesses. The chips are conveyed through a scrubbing section and a rinsing section and then transferred to a drying tray which rotates within a drying oven.

These machines are inefficient and have inherently large footprint in terms of the floor space they occupy.

It is an object of this invention to provide a simple mechanism with a high speed capability.

### BRIEF DESCRIPTION OF THE INVENTION

To this end the present invention provides a machine for cleaning gaming chips or coins which includes
a) feeding means to convey individual coins or chips from the holding means to a carrier wheel
b) said carrier wheel consisting of a vertically oriented disc having arranged about its periphery a plurality of coin or chip sized open recesses to receive individual coins or chips so that the coins or chips are supported on their edges and both faces of the coins or chips are exposed
c) a washing station located adjacent the coin or chip receiving station said carrier wheel conveying the chips or coins through said washing station
d) a drying station located adjacent the washing station and arranged about said carrier wheel such that a drying air stream passes over and around said coins or chips in said carrier wheel
e) a coin or chip collection station adjacent said drying station for receiving washed and dried coins from said carrier wheel.

This system provides a compact and efficient washing and drying system as a single circular carrier conveys the coins or chips through the washing and drying stations in one revolution and allows the machine to have a footprint related to the diameter of the carrier wheel. By holding the coin or chip edge on it is easier to wash and dry both faces of the coin or chip. Preferably the coin or chip recesses in the carrier wheel are crenellated to allow washing fluid and the drying air stream to pass over the edges of the coins or chips as well as the exposed faces. The crenellations may vary in profile from triangular pointed projections to sinusoidal curved edges.

The washing station may include a cleaning section with a wash solution sprayer and brushes and a rinse section with a rinsing solution sprayer.

Preferably the carrier wheel rotates between two parallel enclosure plates spaced from the carrier disc a sufficient distance to allow liquid and air to pass between but insufficient to allow the chips or coins to be dislodged from the carrier. These enclosure plates incorporate slots to allow the passage of liquid into contact with the coins or chips as the carrier wheel rotates through the washing and rinse section. These slots also allow the passage of air as the wheel rotates through the drying chamber. There are openings in one of the plates where the coins or chips are fed into the carrier wheel and an opening in the opposite enclosure plate where the coin or chip leaves the carrier wheel after exiting the drying chamber. The drying section consists of passages on either side of the carrier wheel through which air can flow in a direction opposite to the rotation of the wheel.

The drying chamber is preferably shaped like the segment of a circle to accommodate the edge of the carrier wheel containing the coins or chips. The drying chamber preferably allows an air stream to flow in the opposite direction to the rotation of the carrier wheel and also incorporates baffles to deflect the air stream across the rotating wheel so the drying air passes between the enclosing plates and the wheel and over the faces of the coins or chips and also over the edges of the chips through the crenellations in the edge of the open recesses in the carrier wheel. The air stream may be pushed trough by placing a fan or air pump at the air inlet to force air through the chamber to the air exit or the fan. Alternatively the pump or fan can be positioned at the air outlet to pull the air stream through the chamber. Fans may be positioned at both the inlet and outlets to provide a combined push and pull effect to maintain adequate air flow through the chamber.

The machine preferably includes a hopper adjacent said feeding mechanism for holding coins or chips to be cleaned. The coin or chip holding station includes v or channel shaped trays able to hold columns of the coins or chips. An individual coin or chip is removed from the end of the column and passed in an on edge orientation down a feed tube into the carrier wheel. The collection bin for dried coins or chips may also include an array of v or channel shaped trays to allow columns of coins or chips to be formed as individual coins or chips exit the carrier wheel and are allowed to slide in an on edge orientation into the collection trays.

### DETAILED DESCRIPTION OF THE INVENTION

A preferred embodiment of the invention will be described with reference to the drawings in which

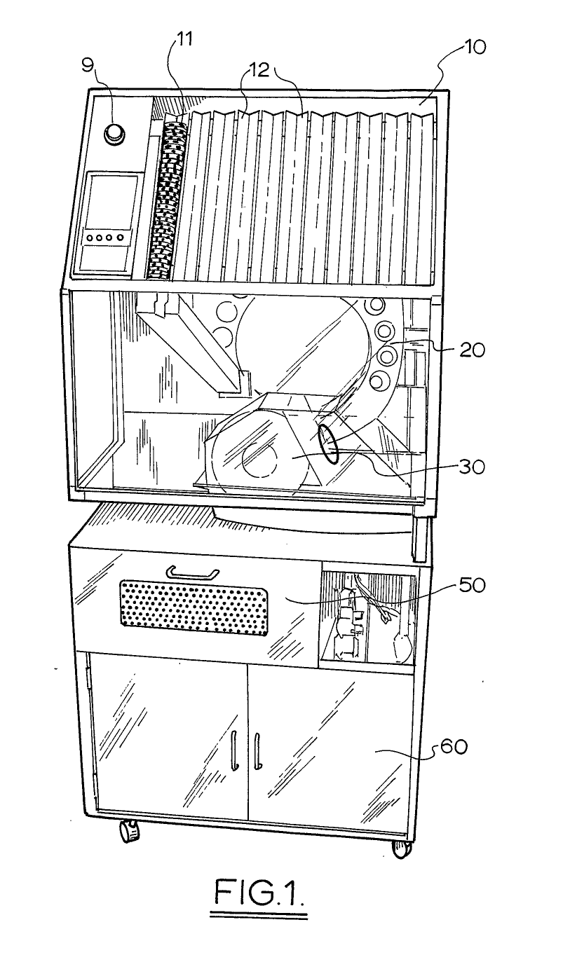

FIG. 1 is a front view of a washing machine according to this invention;

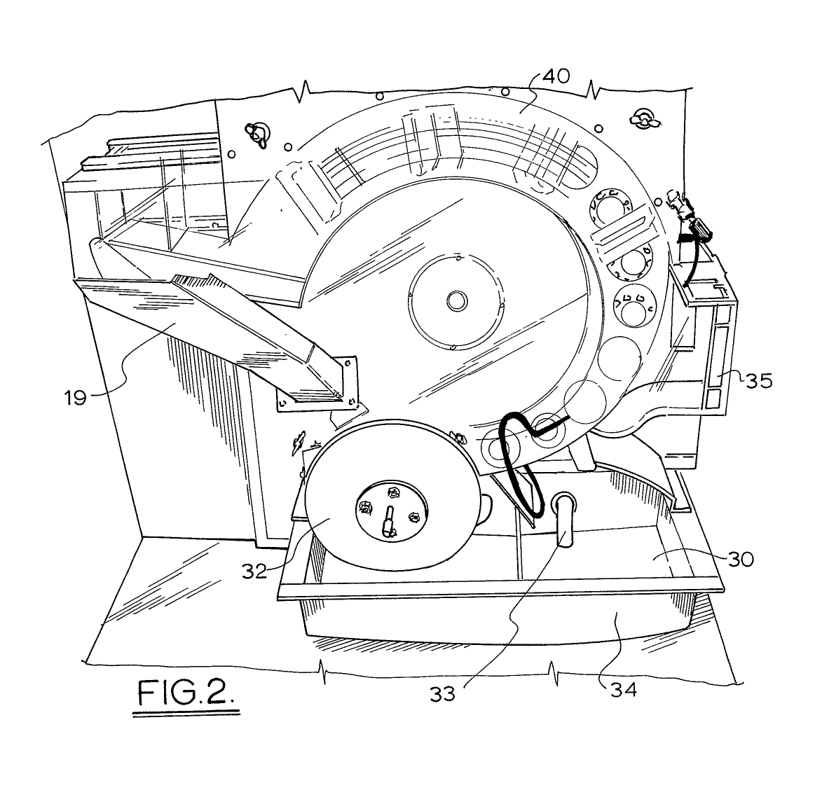

FIG. 2 is a front view of the carrier wheel of this invention;

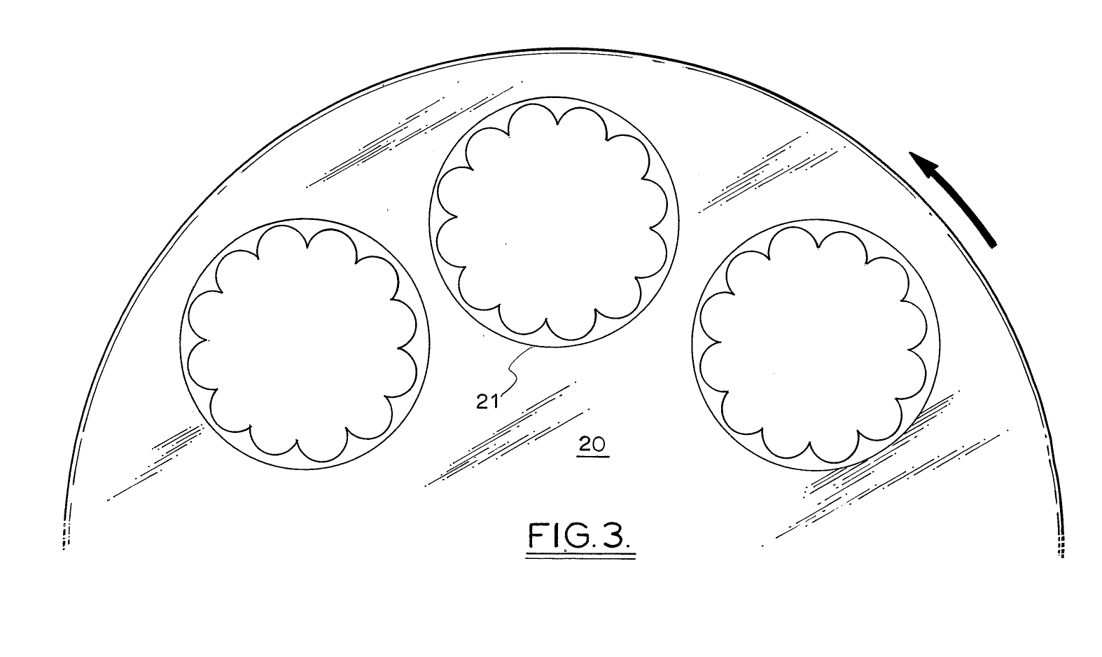

FIG. 3 is detail of the carrier wheel and the open recesses for the coins or chips;

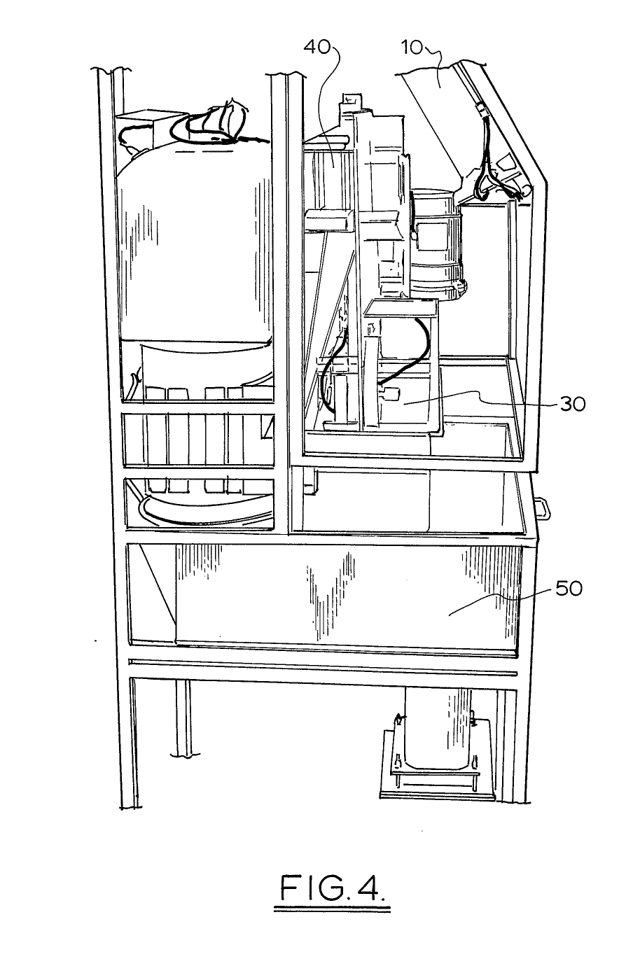

FIG. 4 is a side view of the section shown in FIG. 2;

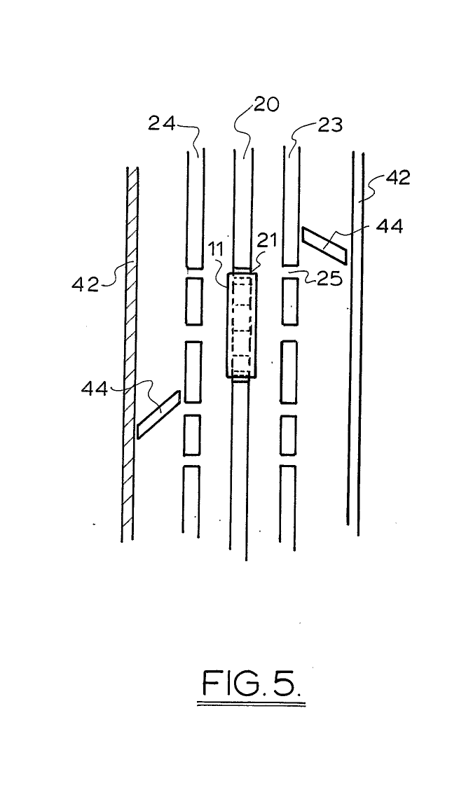

FIG. 5 is a schematic plan view of the drying chamber of this invention.

The washing machine as illustrated in the drawings is designed for gaming chips as used in casinos. The machine as shown in FIG. 1 has a chip holding section 10, a control panel 9, a transport wheel 20, a washing section 30, a drying chamber 40 and a collection bin 50 for washed and dried gaming chips. The section 60 provides access to the cleaning chemicals and rinse water.

The holding section 10 receives columns of chips 11 which are loaded into an array of inclined trays 12 formed from y sections on a central axis so that rotation of the axis anticlockwise by 120° transfers a column of chips 11 to the next tray on the left. An individual chip feed mechanism takes an individual chip from the lowest end of the leftmost tray and feeds this into chute 19 which guides the chip into the carrier wheel 20. The chip feed mechanism may be the same as that described in WO 00/16867. Any mechanism that separates out individual chips or coins for delivery to the carrier wheel may be used.

The carrier wheel 20 has an array of chip holding recesses 21 located around the periphery of the wheel 20. The thickness of the wheel is preferably less than the thickness of a chip so that the faces of the chip are proud of the surfaces of the wheel 20. Enclosure plates 23 at the front and 24 at the rear are located on either side of the wheel 20 to retain the chip 11 within the chip recess 21. The internal edges of each recess 21 is crenellated or grooved to allow the passage of liquid or air around the edges of the chip 11 while held in the recess 21. The crenellations may be curved to create a sinusoidal pattern on the circular edge of each chip recess 21. Plates 23 and 24 include slots 25 which enable liquids and air to pass through into contact with the wheel 20 and the chips 11. The slots may be any shape but are preferably arranged as circumferentially elongated slots adjacent the recesses 21 on the wheel 20. The plate 23 has a cut out section adjacent the end of the chute 19 so that a chip can slide edge on into a recess 21 as the wheel 20 rotates anticlockwise past the end of the chute 19. The carrier wheel can be fabricated from plastics although steel sheet is preferred. Similarly the enclosure plates may also be made from plastic or steel.

The washing section 30 comprises a basin containing a washing basin 33 and a rinse basin 34. Two parallel foam scrubbers 32 on either side of the wheel 20 and are located so that the lower portion of the scrubbers 32 pass through the basin 33 and the upper portion contact the faces of at least one chip 11 in a recess 21 of the wheel 20. The enclosure plates 23 and 24 are cut away to accommodate the upper segment of the brushes 32. As the chip is conveyed away from the scrubbers 32 they are sprayed with rinse water from the spray ring 35 which passes through slots 25 in the plates 23 and 24 and is collected in the rinse basin 34.

The drying section 40 consists of a chamber with walls 42 with interspersed baffles 44 that encloses the upper sector of the wheel 20 and the enclosure plates 23 and 24. The chamber 40 extends from above the rinse trough 34 to a portion of the enclosure plates above the end of chute 19. Warm air is introduced into the drying chamber 40 from the end nearest chute 19 so that it flows counter to the rotation of the carrier wheel. The baffles 44 deflect the air stream across the plates 23 and 24 so that drying air passes over the faces of the chips 11 and through the crenellations in recesses 21 to dry the edges of the chips 11.

Plate 24 has a cutout just above the end of chute 19 to allow chips to fall out of the carrier wheel 20 on the rear side of the machine into a chute that leads to the collection drawer 50. A single chip feeder and inclined collection trays similar to the holding trays 12 in section 10, may be arranged in the collection drawer 50. In operation a fan not shown draws air in through a vent in the collection drawer so that the air is heated by the chips in the drawer and in turn the chips are cooled. This prewarmed air is the passed through a heat exchanger to further raise the temperature before the heated air is introduce into the drying chamber. The machine requires a number of electric motors for driving the
Main carrier wheel drive shaft with timer
Drive shaft for rotary washing brushes
Drive for the movement of the conveying trays 12 in the holding section
Drive shaft for the rotary chip ejector that feed chips individually to the carrier wheel
Fan for the air stream through the drying chamber. A fan may be placed at both the inlet and out let of the drying chamber to provide a combined push and pull effect on the airstream.

The speed of the carrier wheel is determined by the residence time required in the washing and drying sections. A total residence time for each chip that is sufficient to clean and dry the chips will lie in the range of 10 to 20 seconds. With a carrier wheel able to hold 20 chips this means that 3500 to 7000 chips can be cleaned in an hour.

From the above it can be seen that the present invention provides a unique and cost effective way of washing and drying chips with a low residence time for the washing and drying operation.

Those skilled in the art will understand that this invention may be realized in embodiments other than that described without departing from the core teachings of the invention.

1. A machine for cleaning gaming chips or coins which includes
a) feeding means to convey individual coins or chips from the holding means to a carrier wheel
b) said carrier wheel consisting of a vertically oriented disc having arranged about its periphery a plurality of coin or chip sized open recesses to receive individual coins or chips so that the coins or chips are supported on their edges and both faces of the coins or chips are exposed
c) a washing station located adjacent the coin or chip receiving station said carrier wheel conveying the chips or coins through said washing station
d) a drying station located adjacent the washing station and arranged about said carrier wheel such that a drying air stream passes over and around said coins or chips in said carrier wheel
e) a coin or chip collection station adjacent said drying station for receiving washed and dried coins from said carrier wheel.

2. A machine for cleaning gaming chips or coins as claimed in claim 1 in which the coin or chip recesses in the carrier wheel are crenellated to allow washing fluid and the drying air stream to pass over the edges of the coins or chips as well as the exposed faces.

3. A machine as claimed in claim 1 which includes a hopper adjacent said feeding mechanism for holding coins or chips to be cleaned.

4. A machine as claimed in claim 3 in which the hopper includes v or channel shaped trays able to hold columns of the coins or chips on edge.

5. A machine as claimed in claim 1 in which the washing station includes a cleaning section with a wash solution sprayer and brushes and a rinse section with a rinsing solution sprayer.

6. A machine as claimed in claim 1 in which the washing station consists of brushes on either side of said carrier wheel and a washing solution sprayer which applies washing solution to both faces of the coins or chips.

7. A machine as claimed in claim 6 in which the washing solution is collected in a receptacle below the washing station and pumped from the receptacle to the sprayer.

8. A machine as claimed in claim 1 in which the drying section consists of passages on either side of the carrier wheel through which air can flow in a direction opposite to the rotation of the wheel.

9. A machine as claimed in claim 8 in which baffles are located in the passages to direct air toward the coins or chips held in the carrier wheel.

10. A machine as claimed in claim 1 in which fixed support plates are located on either side of the carrier wheel to maintain the coins or chips in said recesses and said support plates have openings or slots in the location of the washing and drying stations.
